(19) United States
(12) Patent Application Publication
(10) Pub. No.: US 2026/0065547 A1
(43) Pub. Date: Mar. 5, 2026

(54) TRAINING-FREE COLOR-STYLE DISENTANGLEMENT FOR CONSTRAINED TEXT-TO-IMAGE SYNTHESIS

(71) Applicant: ADOBE INC., SAN JOSE, CA (US)

(72) Inventors: Aishwarya Agarwal, Bangalore (IN); Srikrishna Karanam, Bangalore (IN); Balaji Vasan Srinivasan, Kasavanahalli (IN)

(21) Appl. No.: 18/821,237

(22) Filed: Aug. 30, 2024

(51) Int. Cl. G06T 11/60; G06T 11/00

(52) U.S. Cl. CPC G06T 11/60; G06T 11/10

(57) ABSTRACT

A method, apparatus, non-transitory computer readable medium, and system for image generation includes obtaining a color input indicating a color attribute, a style input indicating a style attribute, and a content input indicating an image element. A first image generation model generates a color conditioned image based on the color input and the content input, wherein the color conditioned image depicts the image element with the color attribute. A second image generation model generates a style conditioned image based on the style input and the content input, wherein the style conditioned image depicts the image element with the style attribute. A synthetic image is generated by combining the color conditioned image and the style conditioned image, wherein the synthetic image depicts the image element with the color attribute and the style attribute.

### BACKGROUND

The following relates generally to machine learning, and more specifically to image generation using a machine learning model. Machine learning algorithms build a model based on sample data, known as training data, to make a prediction or a decision in response to an input without being explicitly programmed to do so. One area of application for machine learning is image generation.

For example, a machine learning model can be trained to predict features for an image in response to an input prompt, and then generate the image based on the predicted features. In some cases, the prompt can be used to perform complex image manipulation and compositing. Such image generation provides for a user to edit an image and generate an image with desired features and therefore makes image generation easier for a layperson.

### SUMMARY

The present disclosure describes systems and methods for image processing. Embodiments of the present disclosure include an image processing apparatus configured to obtain an input text including an element and generates an output image. Additionally, the image processing apparatus receives a reference color image and a reference style image to further control aspects of the generated image. In some examples, each of the reference color conditioned image and the reference style image are provided by a user. The image processing apparatus, via a diffusion model, combines color information from the reference color conditioned image and style information from the reference style image, and incorporates it into the text input. In some cases, the image processing apparatus preserves essential information of each of the reference images in the generated image.

A method, apparatus, and non-transitory computer readable medium for image processing are described. One or more aspects of the method, apparatus, and non-transitory computer readable medium include obtaining a color input indicating a color attribute, a style input indicating a style attribute, and a content input indicating an image element; generating, using a first image generation model, a color conditioned image based on the color input and the content input, wherein the color conditioned image depicts the image element with the color attribute; generating, using a second image generation model, a style conditioned image based on the style input and the content input, wherein the style conditioned image depicts the image element with the style attribute; and combining the color conditioned image and the style conditioned image to obtain a synthetic image, wherein the synthetic image depicts the image element with the color attribute and the style attribute.

A method, apparatus, and non-transitory computer readable medium for image processing are described. One or more aspects of the method, apparatus, and non-transitory computer readable medium include generating, using a first image generation model, a color conditioned image based on a color input and a content input, wherein the color conditioned image depicts an image element with a color attribute; generating, using a second image generation model, a style conditioned image based on a style input and the content input, wherein the style conditioned image depicts the image element with a style attribute; converting the style conditioned image and the color conditioned image into a style LAB image and a color LAB image, respectively; and combining the style LAB image and the color LAB image to obtain a synthetic image, wherein the synthetic image depicts the image element with the color attribute and the style attribute.

An apparatus, system, and method for image processing are described. One or more aspects of the apparatus, system, and method include a first image generation model comprising parameters stored in the at least one memory component and trained to generate a color conditioned image based on a color input and a content input, wherein the color conditioned image depicts an image element with a color attribute; a second image generation model comprising parameters stored in the at least one memory component and trained to generate a style conditioned image based on a style input and the content input, wherein the style conditioned image depicts the image element with a style attribute; and a fusion component configured to combine the color conditioned image and the style conditioned image to obtain a synthetic image, wherein the synthetic image depicts the image element with the color attribute and the style attribute.

### BRIEF DESCRIPTION OF THE DRAWINGS

FIG. 1 shows an example of an image processing system according to aspects of the present disclosure.

FIG. 2 shows an example of a method for generating an image according to aspects of the present disclosure.

FIG. 3 shows an example of an image combination process according to aspects of the present disclosure.

FIG. 4 shows an example of an image conditioning process according to aspects of the present disclosure.

FIG. 5 shows an example of a guided diffusion architecture according to aspects of the present disclosure.

FIG. 6 shows an example of a U-Net architecture according to aspects of the present disclosure.

FIG. 7 shows an example of a diffusion denoising process according to aspects of the present disclosure.

FIG. 8 shows an example of a method for image processing according to aspects of the present disclosure.

FIG. 9 shows an example of a method for generating a color conditioned image according to aspects of the present disclosure.

FIG. 10 shows an example of a method for generating a style conditioned image according to aspects of the present disclosure.

FIG. 11 shows an example of a computing device according to aspects of the present disclosure.

FIG. 12 shows an example of an image processing apparatus according to aspects of the present disclosure.

FIG. 13 shows an example of a machine learning model according to aspects of the present disclosure.

### DETAILED DESCRIPTION

The following relates generally to image processing, more specifically to text-to-image generation. Image processing refers to the use of a computer to edit an image or analyze an image using an algorithm or a processing network. In some examples, an image processing model takes an input and an editing command and generates an output based on the editing command.

Some image processing systems generate an image based on a text input. These image processing systems may also take additional inputs to further control an attribute of the generated image. For example, according to the present disclosure an image processing system controls a generated image based on color and style attributes using a reference image provided by a user. In some examples, the generated image captures the style and color of the reference image while being aligned with the content in the input text. In some cases, the image processing system is used to perform an appearance transfer, a style transfer, or both, i.e., appearance transfer and style transfer.

The present disclosure describes systems and methods for image processing. Embodiments of the present disclosure include a training-free image processing apparatus configured to obtain an input text including an element and generates an output image. Additionally, the image processing apparatus receives a reference color conditioned image and a reference style image to further control aspects of the generated image. In some examples, each of the reference color conditioned image and the reference style image are provided by a user. The image processing apparatus, via a diffusion model, combines color information from the reference color conditioned image and style information from the reference style image, and incorporates it into the text input. In some cases, the image processing apparatus preserves essential information of each of the reference images in the generated image.

Images are often edited to generate color variants or for recolorization of a given image. In some cases, such recolorization that is conditioned on certain colors can help a user create brand-aligned content. However, conventional editing tools are unable to control aspects of the generated image, such as independently modify color and style attributes of a user-provided reference images. Moreover, such editing tools use extensive training and need custom loss functions to perform independent color and style transfer (e.g., from reference images) for generating a desired output. As a result, a high number of resources are required which is infeasible. Moreover, user experience (e.g., content creators and audience viewing the edited image) and content quality are decreased.

Embodiments of the present disclosure include an image generation model that improves conventional editing tools by generating more accurate images, that is, images that more accurately reflect desired color and style attributes. The enhanced ability to depict target attributes (e.g., style and color) can be achieved by generating separate color and style conditioned images, and combining them to form a synthetic image that includes both color and style elements. Some embodiments use a time-step constrained image generation algorithm. For example, in some cases, the image generation model includes a training-free method to disentangle and control text-to-image diffusion models on color and style attributes from reference images.

Embodiments of the present disclosure include an image processing apparatus configured to generate an attribute constrained image based on a reference image and a text input. In some cases, an attribute constrained image includes a style reference image and a color reference image that are used to transfer style and color, respectively to an output image. The image processing apparatus includes a training-free machine learning model that enables independent control over the attribute of the generated output image. According to an embodiment, the image processing apparatus includes a plurality of diffusion models, each for independently capturing the style and color attribute of the reference image. In some cases, a diffusion model is used to generate a content image based on the text input. A synthetic (i.e., an output) image is then generated based on combining the captured features of the reference image and the content image.

According to an embodiment of the present disclosure, the image processing apparatus is configured to perform a time-step constrained recoloring transformation. In some cases, embodiments provide a training free method that uses latent code based recoloring transformation to align the output of the text-to-image generation process (i.e., content image) with the color reference image. Accordingly, the recoloring transformation method of the present disclosure enables transfer of colors from the reference image to the content image to generate a color conditioned image.

According to an embodiment of the present disclosure, the image processing apparatus is configured to perform a time-step constrained style transformation. In some cases, embodiments provide a training free method that uses a self-attention key and value feature manipulation algorithm to generate a style conditioned image that aligns the content image with the style reference image. Accordingly, the style transformation method of the present disclosure enables transfer of style from the reference image to the content image to generate a style conditioned image. The image processing apparatus is further configured to generate an output (e.g., synthetic) image based on combining the color conditioned image and the style conditioned image.

The present disclosure describes systems and methods to perform disentangled color and style control of text-to-image models. Embodiments of the present disclosure include a training-free, test-time method configured to align the color of a generated image with a user-provided color input and configured to align the style of the generated image with a user-provided style input. In some cases, the method is configured to perform a timestep-constrained latent code recoloring transformation that aligns colors of the synthetic image with the user-provided color input. In some cases, the method is configured to perform a timestep-constrained self-attention feature manipulation strategy in the L channel of the LAB space that aligns style of the synthetic image with the user-provided style input. Therefore, embodiments are able to independently perform a color-only, style-only, or both color-style conditioning in a disentangled manner.

Additionally, by performing a training-free test-time method that provides for independent control over color and style attributes (obtained from a reference image) while generating images using text-to-image diffusion models, embodiments of the present disclosure are able to perform reference image-based color and style constrained generation without retraining the machine learning model. Moreover, embodiments provide for a method that enables recoloring an image which can be used to generate color variants of the image resulting in user brand color palettes providing for creation of brand-aligned content.

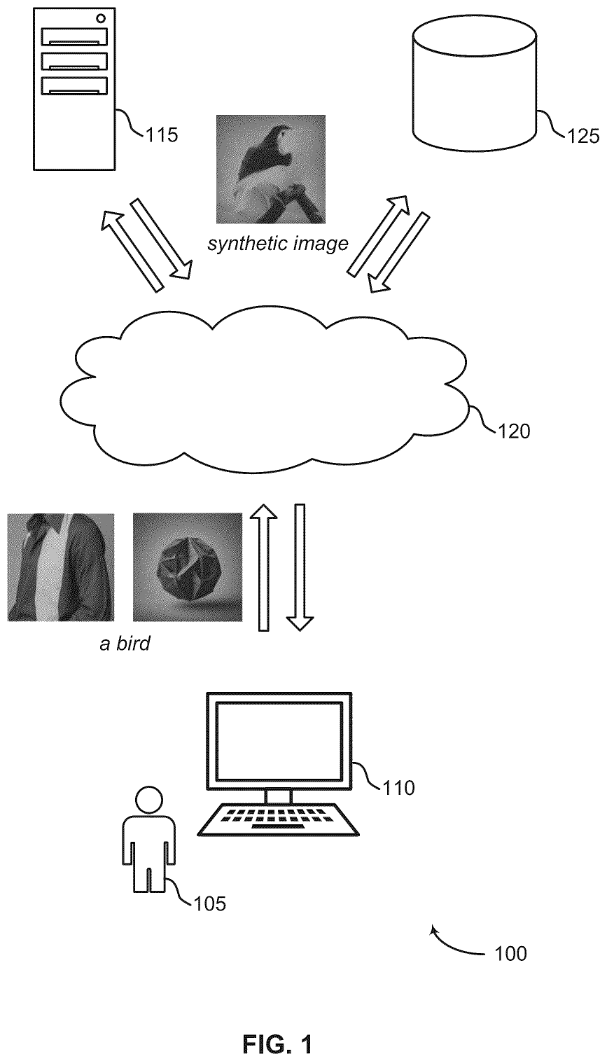

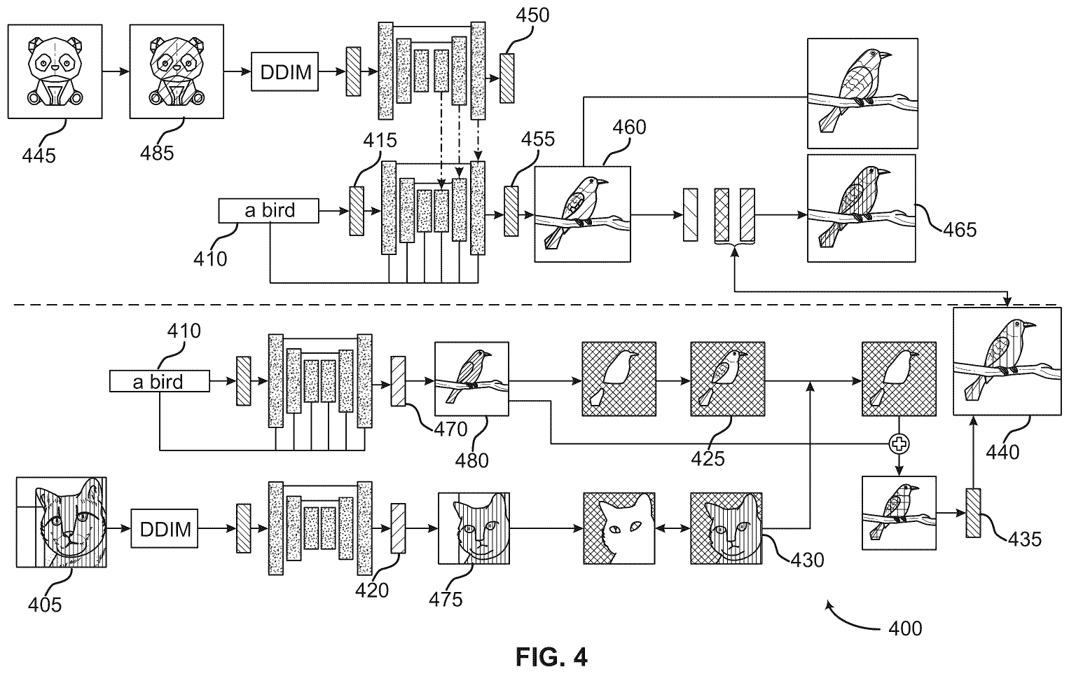

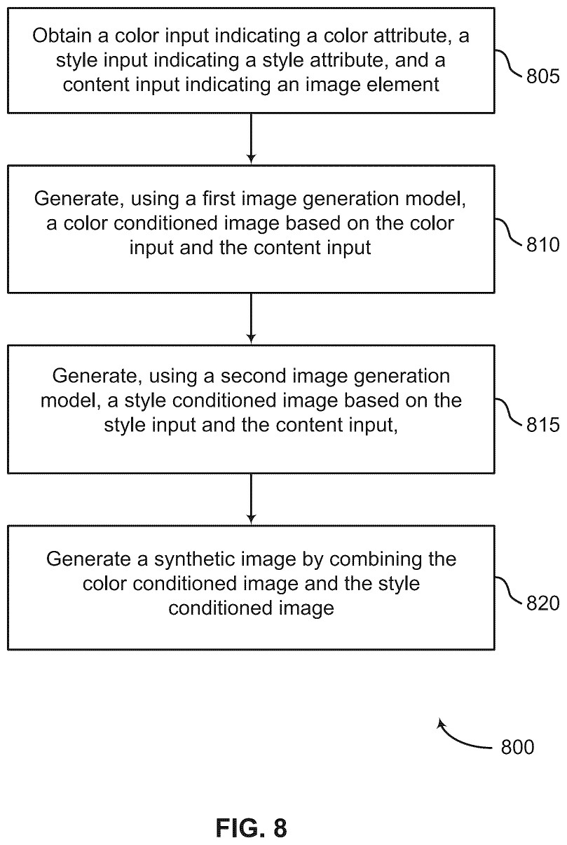

Embodiments of the present disclosure can be used in the context of image generation applications. For example, a machine learning model based on the present disclosure takes a prompt (e.g., text-based prompt) and a reference image corresponding to an attribute as input and efficiently generates a synthetic image. Example applications regarding generating a synthetic image that depicts attributes captured from the text prompt and the reference image are provided with reference to FIGS. 1-3. Details regarding the architecture of the machine learning model are provided with reference to FIGS. 4-7 and 11-13. Examples of a process for generating the synthetic image are provided with reference to FIGS. 8-10.

### Image Generation System

A system and an apparatus for image processing are described with reference to FIGS. 1-7. FIG. 1 shows an example of an image processing system 100 according to aspects of the present disclosure. In one aspect, image processing system 100 includes user 105, user device 110, image processing apparatus 115, cloud 120, and database 125.

In the example of FIG. 1, user 105 provides a reference image and an input prompt to image processing apparatus 115 via a user interface provided on user device 110 by image processing apparatus 115. In some cases, the input prompt is a text input. As used herein, text prompt describes an element provided by a user to generate an output or synthetic image. As an example shown in FIG. 1, the user provides a text prompt that describes the element the user wants to generate using the image processing apparatus 115 of the present disclosure. According to some aspects, image processing apparatus 115 obtains an input prompt, i.e., description of an element (e.g., “a bird”).

In some cases, the image processing apparatus 115 implements an image conditioning process (such as the image conditioning process described with reference to FIGS. 4 and 8-10) to generate a synthetic image based on the text prompt. In some cases, as shown in FIG. 1, the user provides an image (e.g., a reference image) to the image processing apparatus 115, features of which the user wants to capture in the synthetic image. In some examples, the image processing apparatus 115 generates a synthetic image that incorporates the color and style attributes depicted in the reference image into the element provided by the text prompt. In some cases, the image processing apparatus generates a synthetic image that depicts the bird which incorporates the style and color from the reference images provided by the user, e.g., the synthetic image depicts the bird with the color of the shirt of the first reference image and the style/texture of the ball in the second reference image.

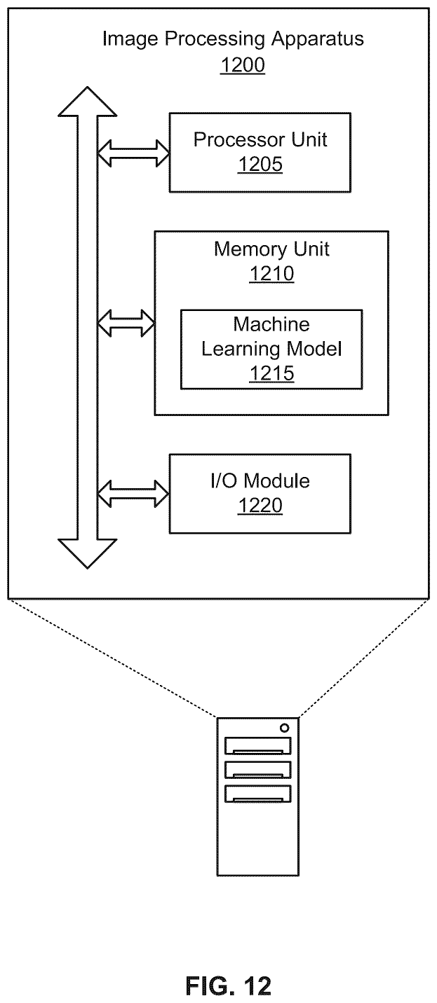

Referring to the example of FIG. 1, the image processing apparatus 115 provides the synthetic image to user 105 via the user interface provided on user device 110. According to some aspects, user device 110 is a personal computer, laptop computer, mainframe computer, palmtop computer, personal assistant, mobile device, or any other suitable processing apparatus. In some examples, user device 110 includes software that displays a user interface (e.g., a graphical user interface) provided by image processing apparatus 115. In some aspects, the user interface provides for information (such as images (custom images or synthetic image), a prompt, etc.) to be communicated between user 105 and image processing apparatus 115. Image processing apparatus 115 is an example of, or includes aspects of, the corresponding element described with reference to FIG. 12.

According to some aspects, a user device user interface enables user 105 to interact with user device 110. In some embodiments, the user device user interface may include an audio device, such as an external speaker system, an external display device such as a display screen, or an input device (e.g., a remote-control device interfaced with the user interface directly or through an I/O controller module). In some cases, the user device user interface may be a graphical user interface.

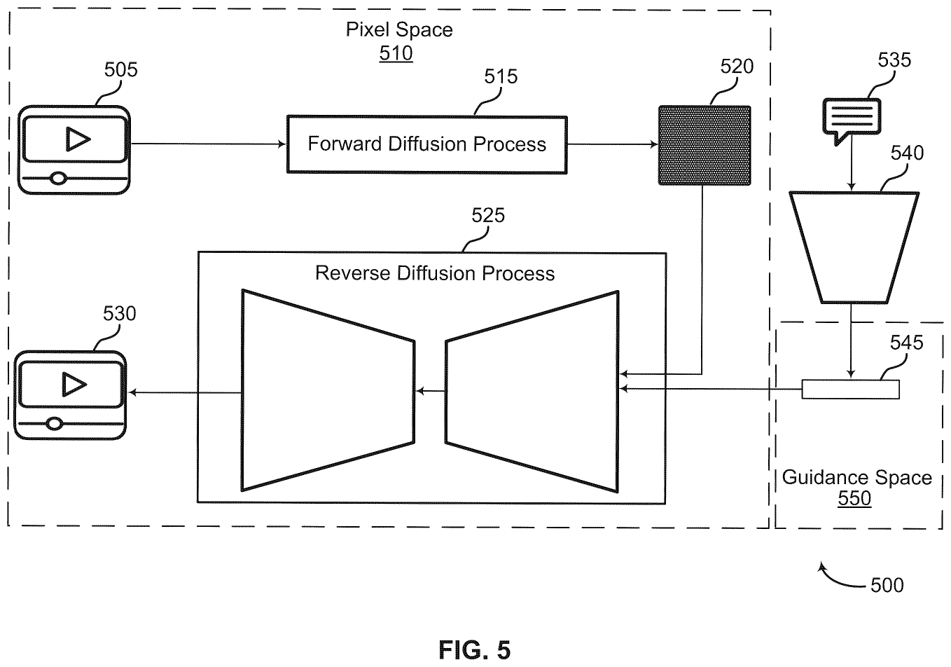

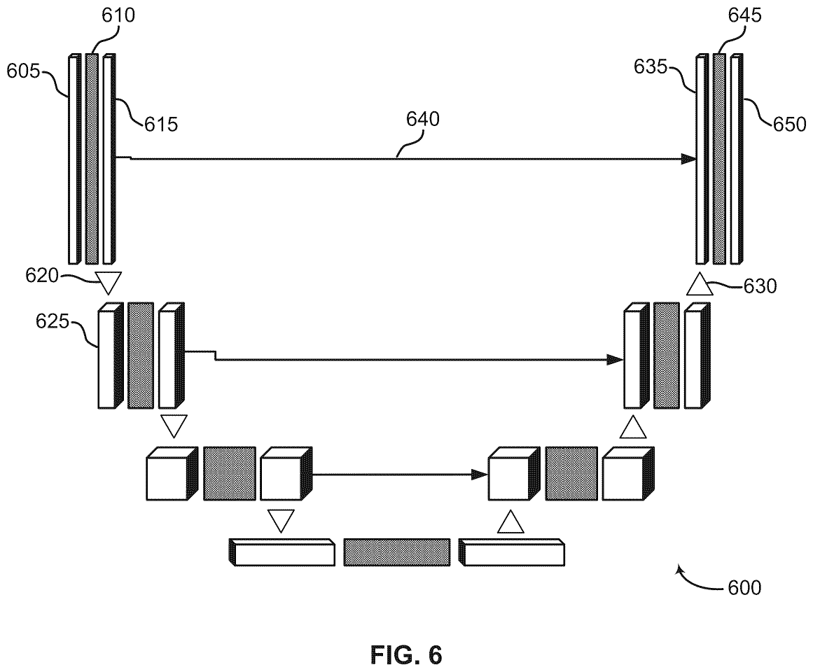

According to some aspects, image processing apparatus 115 includes a computer-implemented network. In some embodiments, the computer-implemented network includes a machine learning model (such as the image generation model described with reference to FIGS. 5 and 6). In some embodiments, image processing apparatus 115 also includes one or more processors, a memory subsystem, a communication interface, an I/O interface, one or more user interface components, and a bus as described with reference to FIG. 12. Additionally, in some embodiments, image processing apparatus 115 communicates with user device 110 and database 125 via cloud 120.

In some cases, image processing apparatus 115 is implemented on a server. A server provides one or more functions to users linked by way of one or more of various networks, such as cloud 120. In some cases, the server includes a single microprocessor board, which includes a microprocessor responsible for controlling all aspects of the server. In some cases, the server uses microprocessor and protocols to exchange data with other devices or users on one or more of the networks via hypertext transfer protocol (HTTP), and simple mail transfer protocol (SMTP), although other protocols such as file transfer protocol (FTP), and simple network management protocol (SNMP) may also be used. In some cases, the server is configured to send and receive hypertext markup language (HTML) formatted files (e.g., for displaying web pages). In various embodiments, the server comprises a general-purpose computing device, a personal computer, a laptop computer, a mainframe computer, a supercomputer, or any other suitable processing apparatus.

Cloud 120 is a computer network configured to provide on-demand availability of computer system resources, such as data storage and computing power. In some examples, cloud 120 provides resources without active management by a user. The term “cloud” is sometimes used to describe data centers available to many users over the Internet. Some large cloud networks have functions distributed over multiple locations from central servers. A server is designated an edge server if it has a direct or close connection to a user. In some cases, cloud 120 is limited to a single organization. In other examples, cloud 120 is available to many organizations. In one example, cloud 120 includes a multi-layer communications network comprising multiple edge routers and core routers. In another example, cloud 120 is based on a local collection of switches in a single physical location. According to some aspects, cloud 120 provides communications between user device 110, image processing apparatus 115, and database 125.

Database 125 is an organized collection of data. In an example, database 125 stores data in a specified format known as a schema. According to some aspects, database 125 is structured as a single database, a distributed database, multiple distributed databases, or an emergency backup database. In some cases, a database controller manages data storage and processing in database 125. In some cases, a user interacts with the database controller. In other cases, the database controller operates automatically without interaction from the user. According to some aspects, database 125 is external to image processing apparatus 115 and communicates with image processing apparatus 115 via cloud 120. According to some aspects, database 125 is included in image processing apparatus 115.

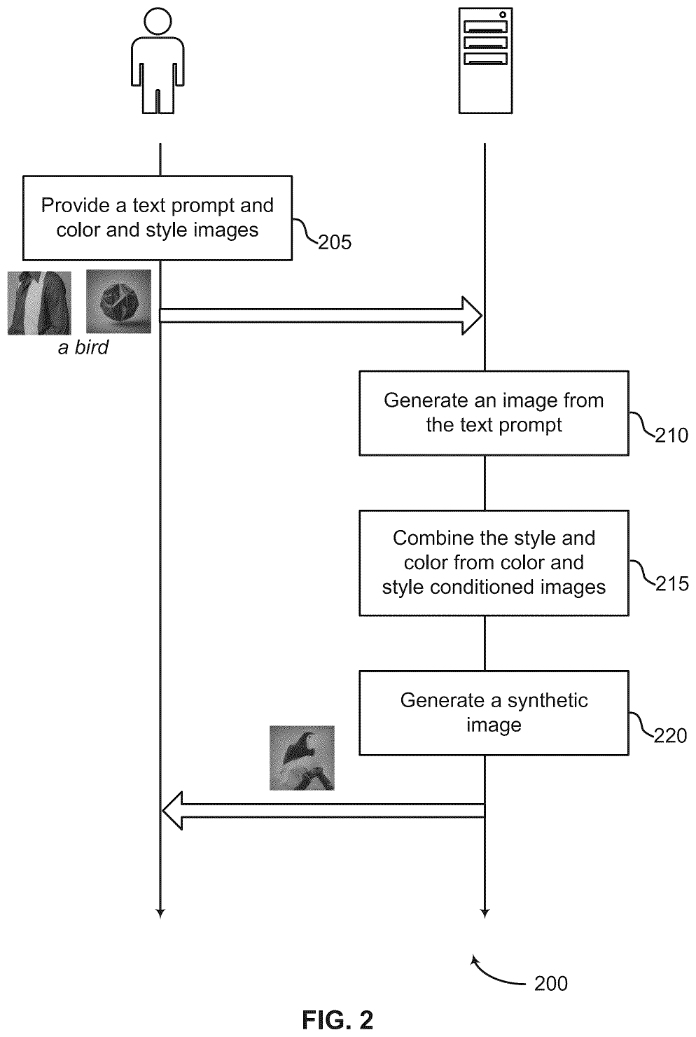

FIG. 2 shows an example of a method 200 a method for generating an image according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

According to an embodiment of the present disclosure, an image processing apparatus (such as the image processing apparatus described with reference to FIGS. 1 and 4) provides a machine learning model (such as the machine learning model described with reference to FIGS. 4-7 and 12-13) that generates a synthetic image depicting an element based on an input text prompt and that incorporates the color and style from a user-provided reference image.

At operation 205, the system provides a text prompt and color and style conditioned images. In some cases, the operations of this step refer to, or may be performed by, a user as described with reference to FIG. 1.

In some examples, the user provides a text prompt to the image processing apparatus (such as the image processing apparatus described with reference to FIG. 1). As shown in FIG. 2, the text prompt includes an element that the user wants to modify the style and color for. In some cases, the user provides a color reference image (e.g., depicting a shirt) and a style reference image (e.g., depicting a ball with sharp edges and lines) for incorporation into the synthetic image. For example, the user wants the synthetic (i.e., output) image to include an image of the “bird” specified in the text prompt that incorporates the style and color of the reference images provided by the user. In some cases, the user provides the text prompt and the reference images to the image processing apparatus via a user interface (such as a graphical user interface) provided on a user device by the image processing apparatus.

At operation 210, the system generates an image based on the text prompt. In some cases, the operations of this step refer to, or may be performed by, an image processing apparatus as described with reference to FIGS. 1 and 4. In some cases, the image processing apparatus generates the image based on the text prompt. In some examples, the image processing apparatus uses a diffusion model to perform text-to-image generation. Further details regarding this operation are provided with reference to FIGS. 4-7.

At operation 215, the system combines the color and style from color and style conditioned images into the generated image. In some cases, the operations of this step refer to, or may be performed by, an image processing apparatus as described with reference to FIGS. 1 and 12.

In some examples, the image processing apparatus implements a training-free method that independently combines the image generated at operation 210 with color and style attributes of a user-provided reference image (e.g., the color reference image and style reference image provided by the user in operation 205). According to an embodiment, the image processing apparatus generates a color conditioned image that incorporates the color attribute of the reference image (such as the reference image received in operation 205) into the image (such as the image generated at operation 210 including an element described in the text prompt).

In some cases, the color conditioned image is generated based on a time-step-constrained (training-free) latent code recoloring transformation that aligns the covariance matrices of the image (such as the image generated at operation 210 including an element described in the text prompt) with the covariance matrices of a reference image (such as the reference image provided by the user in operation 205).

Additionally, the image processing apparatus generates a style conditioned image that incorporates the style attribute of the reference image (such as the reference image received in operation 205) into the image (such as the image generated at operation 210 including an element described in the text prompt). In some cases, the style conditioned image is generated based on a time-step-constrained (training-free) self-attention key and value feature manipulation algorithm to transfer style from a reference image (such as the reference image provided by the user in operation 205) to the image generated at operation 210 including an element described in the text prompt.

At operation 220, the system generates a synthetic image using the combination. In some cases, the operations of this step refer to, or may be performed by, an image processing apparatus as described with reference to FIGS. 1 and 12.

Embodiments of the present disclosure include an image processing apparatus configured to perform a training-free process (such as the process described in operation 215 and further described in detail with reference to FIGS. 4 and 8-10) to provide for disentangled conditioning of text-to-image diffusion models on color and style attributes from a reference image. In some cases, the image processing apparatus combines the color conditioned image (e.g., color conditioned image generated in operation 215) and the style conditioned image (e.g., style conditioned image generated in operation 215) to generate a synthetic image.

For example, the synthetic image depicts the bird with a color from the first reference image (e.g., bird with a color of the shirt in the reference image) and a style from the second reference image (e.g., bird with the style of the ball in the reference image). For example, in some cases, the image processing apparatus displays the synthetic image to the user via the user interface (such as the user interface described with reference to FIG. 1).

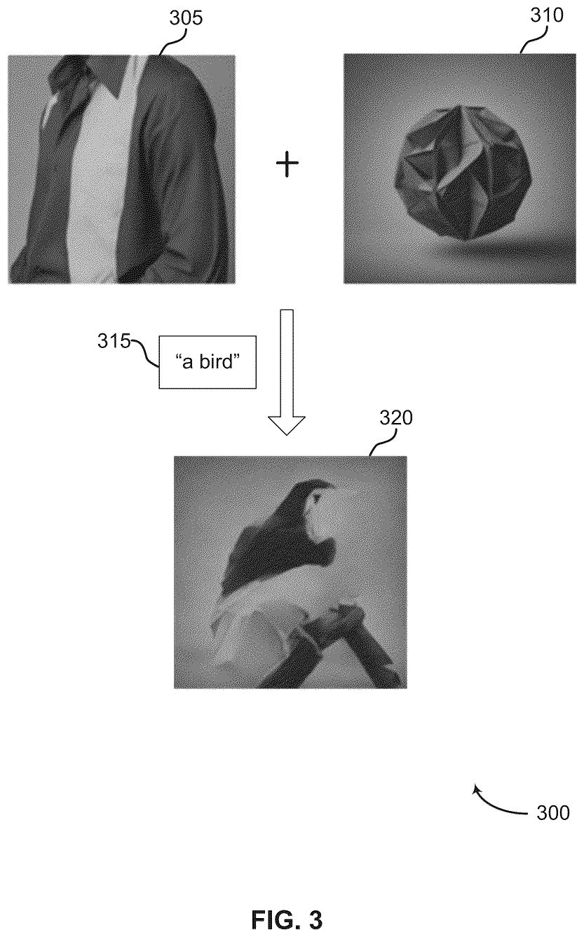

FIG. 3 shows an example of an image combination process 300 according to aspects of the present disclosure. In one aspect, image combination process 300 includes color input 305, style input 310, content input 315, and synthetic image 320.

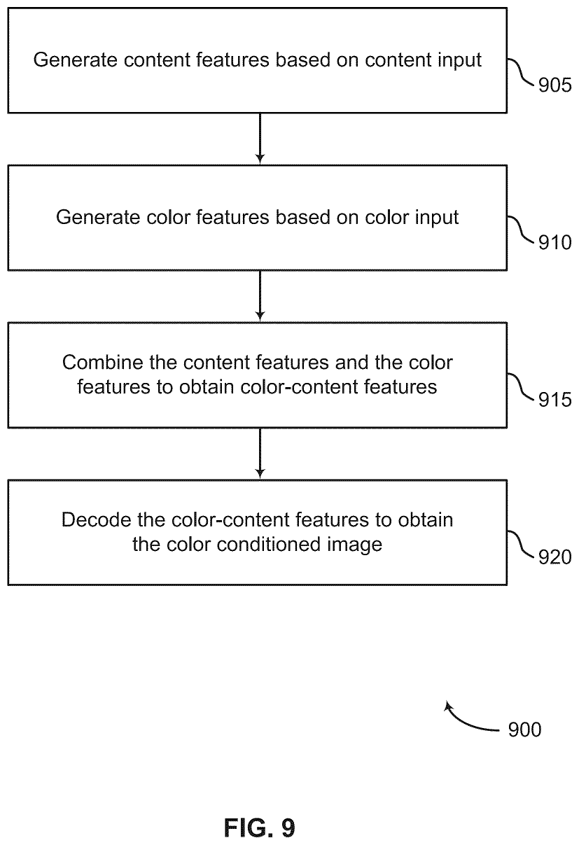

Referring to FIG. 3, color input 305 includes an element depicting a color. In some cases, color input 305 depicts a plurality of colors. For example, color input 305 includes a color the user wants to capture in the synthetic image (such as synthetic image described with reference to FIGS. 1-2). In some examples, color input 305 shows a blue and yellow shirt and the user wants to generate a synthetic image with an element that is blue and yellow in color. Color input 305 is an example of, or includes aspects of, the corresponding element described with reference to FIG. 4. Further details regarding the color input 305 are provided with reference to FIGS. 3 and 9.

Additionally, FIG. 3 shows a style input 310 that depicts a style or texture of an image (or, e.g., a style and texture of an element in an image). For example, style input 310 includes a style the user wants to capture in the synthetic image (such as synthetic image described with reference to FIGS. 1-2). Style input 310 is an example of, or includes aspects of, the corresponding element described with reference to FIG. 4.

As shown in FIG. 3, the image processing apparatus (such as the image processing apparatus described with reference to FIGS. 1, 4, and 11-12) receives content input 315 from the user. In some cases, the content input 315 is a text prompt provided by the user. For example, referring to FIG. 3, the content input 315 specifies “a bird” that the user wants to generate while incorporating the aspects of color input 305 and style input 310. Content input 315 is an example of, or includes aspects of, the corresponding element described with reference to FIG. 4.

Embodiments of the present disclosure are configured to perform disentangled control to generate a synthetic image that is conditioned to capture color from color input and style from style input. In some examples, the image processing apparatus generates a synthetic image 320 that is aligned with the content from content input 315, while following the color and style from color input 305 and style input 310, respectively. For example, synthetic image 320 depicts a bird (such as specified in content input 315) that captures the multiple colors from color input 305 and the style (such as the straight and sharp edges) from style input 310. Synthetic image 320 is an example of, or includes aspects of, the corresponding element described with reference to FIG. 4. Further details regarding the combination of the color input 305 and style input 310 are provided with reference to FIGS. 4 and 8-10.

FIG. 4 shows an example of an image conditioning process 400 according to aspects of the present disclosure.

In one aspect, image conditioning process 400 includes color input 405, content input 410, content features 415, noise 420, content mask 425, content noise 470, decoded image 475, color mask 430, color content features 435, color conditioned image 440, style input 445, style features 450, style content features 455, style conditioned image 460, and synthetic image 465.

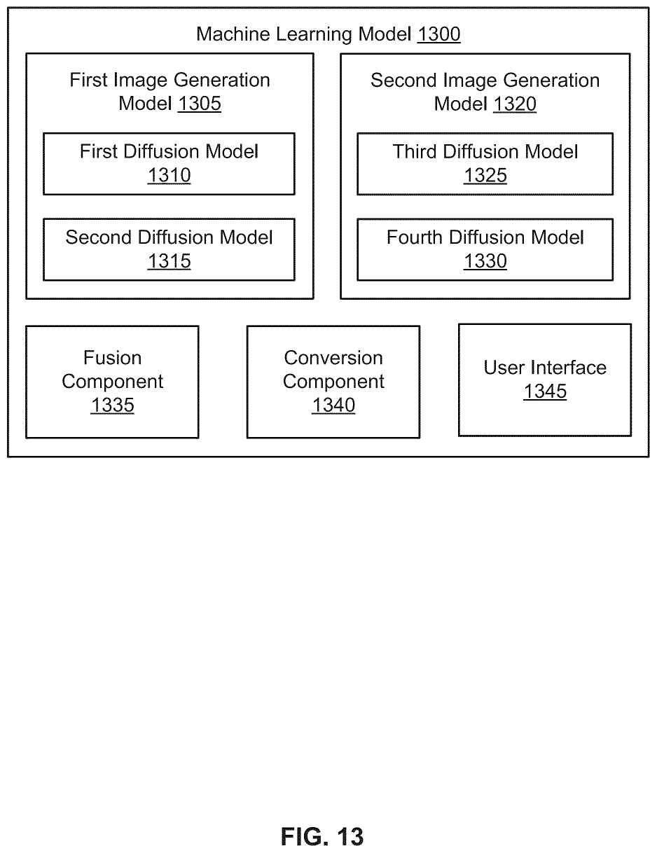

An embodiment of the present disclosure is configured to perform an image conditioning process that can independently control an output of a text-to-image model based on disentangled color and style conditioning. In some cases, the disentangled control implies that the color information and style information is captured from different references (i.e., different reference images). In some cases, a synthetic image is generated based on combining a color of the color reference image and a style of the style reference image. The image conditioning process is a test-time and training-free process that does not perform training of the machine learning model (such as the machine learning model described in FIGS. 12-13) for each new reference image.

According to an embodiment of the present disclosure, the machine learning model generates a synthetic image that is conditioned on different attributes (e.g., color and/or style attribute) of a reference image. FIG. 3 shows generation of image of a bird (i.e., synthetic image 465) based on content input 410 and conditioned to incorporate the color of color input 405 and the style of style input 445. Color input 405 is an example of, or includes aspects of, the corresponding element described with reference to FIG. 3. Content input 410 is an example of, or includes aspects of, the corresponding element described with reference to FIG. 3. Style input 445 is an example of, or includes aspects of, the corresponding element described with reference to FIG. 3. Synthetic image 465 is an example of, or includes aspects of, the corresponding element described with reference to FIG. 3.

As shown in FIG. 4, the machine learning model generates color conditioned image 440 based on content input 410 that is conditioned on the color of color input 405. For example, color input 405 shows a blue cat. As such, color conditioned image 440 is of the same color (e.g., blue) as the color input 405. Further, the machine learning model merges the color conditioned image 440 and style conditioned image 460 such that the color and style captured from the color input and style input in synthetic image 465 is controlled.

According to an embodiment, the image processing apparatus (such as the image processing apparatus 1200 described with reference to FIG. 12) takes a color input 405 to generate noise

$$( {ϵ}_{θ}^{{( t )}_{ref}} )$$

420 based on a denoising diffusion implicit model (DDIM). Additionally, the image processing apparatus takes a content input 410 to generate content noise

$$( {ϵ}_{θ}^{{( t )}_{gen}} )$$

470. Further details regarding the DDIM are provided with reference to FIGS. 5-7.

In some cases, the machine learning model performs a K-means clustering operation on the reference image

$$( {z}_{0}^{{( t )}_{ref}} )$$

475 that generates color mask 430. In some cases, the machine learning model performs a K-means clustering operation on the latent code

$$( {z}_{0}^{{( t )}_{gen}} )$$

480 that generates content mask 425. Further details regarding the generation of the color mask and the K-means clustering operation are provided with reference to FIG. 9. The content mask 425 and color mask 430 are combined to generate color content features 435 which is decoded to generate color conditioned image 440.

According to an embodiment, the machine learning model generates style conditioned image 460 based on content input 410 that is conditioned on the style of style input 445. For example, style input 445 shows a panda with an origami style. Therefore, style conditioned image 460 is of the same style (e.g., origami) as the style input 445.

The image processing apparatus takes as input a grayscale version 485 of the style input 445. In some cases, the machine learning model of the present disclosure performs a DDIM inversion on the grayscale image to obtain a latent

$$( {z}_{t}^{ref} ) .$$

Additionally, for a content input 410, in case of each denoising timestep, the machine learning model denoises an input latent 415

$$( {z}_{t}^{g e n} ) .$$

At a timestep t, self-attention key K and value V feature maps from the reference reconstruction (i.e., obtained by performing a DDIM inversion process on the grayscale image 485) are injected in the content input during reconstruction.

As shown in FIG. 4, a modified self-attention feature map is generated based on the injected self-attention key K and value V feature maps from the reference reconstruction. Additionally, style content features

$$( {z}_{t - 1}^{g e n} )$$

455 are generated based on the modified self-attention feature map. The style content features

$$( {z}_{t - 1}^{g e n} )$$

455 are decoded to generate style conditioned image 460.

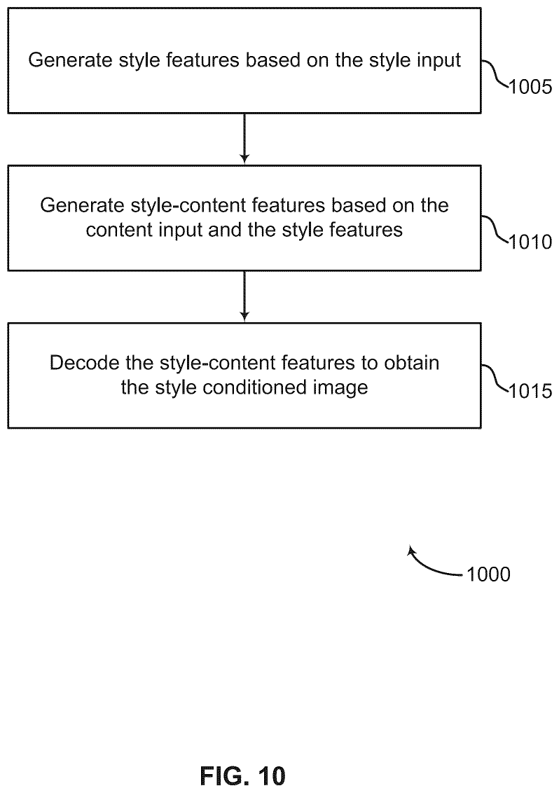

According to an embodiment, the machine learning model converts style conditioned image 460 to the LAB space and retains the L channel. In some cases, the machine learning model converts color conditioned image 440 to the LAB space and obtains the AB channels. Synthetic image 465 is generated based on combining the L channel of style conditioned image 460 and AB channels of color conditioned image 440. Further detail regarding generation of synthetic image 465 is described with reference to FIG. 8. Further detail regarding generation of color conditioned image 440 is described with reference to FIG. 9. Further detail regarding generation of style conditioned image 460 is described with reference to FIG. 10.

FIG. 5 shows an example of a guided diffusion model 500 according to aspects of the present disclosure. In some examples, guided diffusion model 500 describes the operation and architecture of the machine learning model 1215 described with reference to FIG. 12 or machine learning model 1300 described with reference to FIG. 13. The guided latent diffusion model 500 depicted in FIG. 5 is an example of, or includes aspects of, a media generation model as described herein.

Diffusion models are a class of generative neural networks which can be trained to generate new data with features similar to features found in training data. In particular, diffusion models can be used to generate novel media items such as images, audio files, videos, three-dimensional (3D) models or other digital media items. Diffusion models can be used for various media processing tasks including image super-resolution, generation of media items with perceptual metrics, conditional generation (e.g., generation based on text guidance), image inpainting, and media manipulation.

Diffusion models work by iteratively adding noise to the data during a forward process and then learning to recover the data by denoising the data during a reverse process. For example, during training, guided latent diffusion model 500 may take an original media item 505 in a pixel space 510 as input and apply forward diffusion process 515 to gradually add noise to the original media item 505 to obtain noisy media item 520 at various noise levels.

Next, a reverse diffusion process 525 (e.g., a U-Net) gradually removes the noise from the noisy media item 520 at the various noise levels to obtain an output media item 530. In some cases, an output media item 530 is created from each of the various noise levels. The output media item 530 can be compared to the original media item 505 to train the reverse diffusion process 525.

The reverse diffusion process 525 can also be guided based on a text prompt 535, or another guidance prompt, such as an image, a layout, a segmentation map, etc. The text prompt 535 can be encoded using a text encoder 565 (e.g., a multimodal encoder) to obtain guidance features 545 in guidance space 550. The guidance features 545 can be combined with the noisy media item 520 at one or more layers of the reverse diffusion process 525 to ensure that the output media item 530 includes content described by the text prompt 535. For example, guidance features 545 can be combined with the noisy features using a cross-attention block within the reverse diffusion process 525.

Methods of operating diffusion models include a Denoising Diffusion Probabilistic Model (DDPM) and a Denoising Diffusion Implicit Models (DDIM). In DDPM, the generative process includes reversing a stochastic Markov diffusion process. DDIMs, on the other hand, use a deterministic process so that the same input results in the same output. In some cases, DDIM can reduce the number of timesteps during media generation. Diffusion models may also be characterized by whether the noise is added to the media item itself, or to media features generated by an encoder (i.e., latent diffusion). In a pixel diffusion model, noise is added and removed in pixel space. In a latent diffusion model, the noise is added (and removed) in a latent space of media features rather than in pixel space. Thus, a latent diffusion model generates media features using reverse diffusion, and these media features can be decoded to obtain a synthetic media item. DDIM is an example of, or includes aspects of, the corresponding element described with reference to FIGS. 2, 6, 7, and 11.

FIG. 6 shows an example of a U-Net 600 according to aspects of the present disclosure. In some examples, U-Net 600 is an example of the component that performs the reverse diffusion process 525 of guided diffusion model 500 described with reference to FIG. 5 and includes architectural elements of the machine learning model 1215 described with reference to FIG. 12 or machine learning model 1300 described with reference to FIG. 13. The U-Net 600 depicted in FIG. 6 is an example of, or includes aspects of, the architecture used within the reverse diffusion process described with reference to FIG. 5.

In some examples, diffusion models are based on a neural network architecture known as a U-Net. The U-Net 600 takes input features 605 having an initial resolution and an initial number of channels and processes the input features 605 using an initial neural network layer 610 (e.g., a convolutional network layer) to produce intermediate features 615. The intermediate features 615 are then down-sampled using a down-sampling layer 620 such that down-sampled features 625 features have a resolution less than the initial resolution and a number of channels greater than the initial number of channels.

This process is repeated multiple times, and then the process is reversed. That is, the down-sampled features 625 are up-sampled using up-sampling process 630 to obtain up-sampled features 635. The up-sampled features 635 can be combined with intermediate features 615 having the same resolution and number of channels via a skip connection 640. These inputs are processed using a final neural network layer 645 to produce output features 650. In some cases, the output features 650 have the same resolution as the initial resolution and the same number of channels as the initial number of channels.

In some cases, U-Net 600 takes additional input features to produce conditionally generated output. For example, the additional input features could include a vector representation of an input prompt. The additional input features can be combined with the intermediate features 615 within the neural network at one or more layers. For example, a cross-attention module can be used to combine the additional input features and the intermediate features 615. U-Net architecture is an example of, or includes aspects of, the corresponding element described with reference to FIGS. 2, 5, 7, and 11.

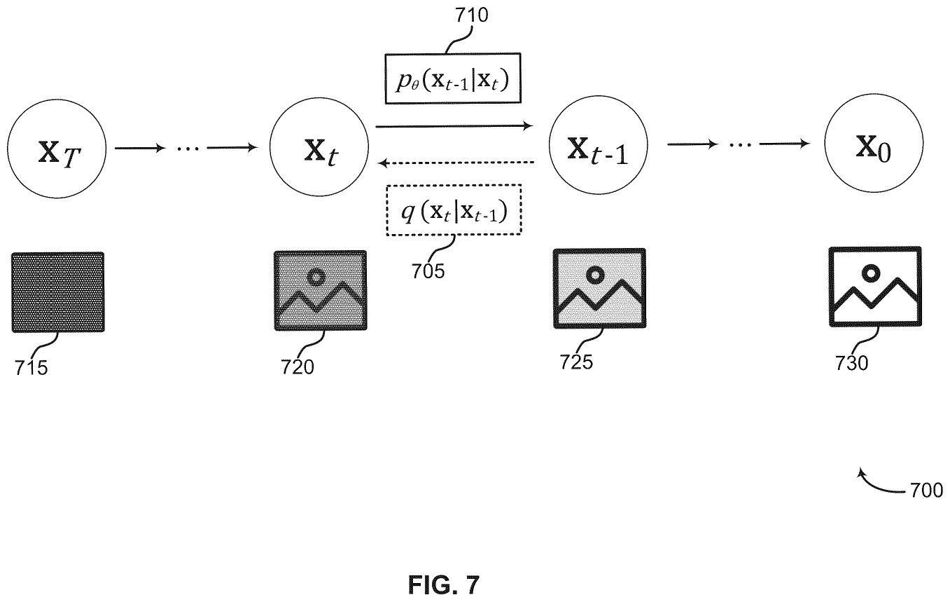

FIG. 7 shows a diffusion process 700 according to aspects of the present disclosure. In some examples, diffusion process 700 describes an operation of the machine learning model 1215 described with reference to FIG. 12 or machine learning model 1300 described with reference to FIG. 13, such as the reverse diffusion process 525 of guided diffusion model 500 described with reference to FIG. 5.

As described above with reference to FIG. 5, using a diffusion model can involve both a forward diffusion process 705 for adding noise to a media item (or features in a latent space) and a reverse diffusion process 710 for denoising the media item (or features) to obtain a denoised media item. The forward diffusion process 705 can be represented as q(xₜ|xₜ₋₁), and the reverse diffusion process 710 can be represented as p(xₜ₋₁|xₜ). In some cases, the forward diffusion process 705 is used during training to generate media items with successively greater noise, and a neural network is trained to perform the reverse diffusion process 710 (i.e., to successively remove the noise).

In an example forward process for a latent diffusion model, the model maps an observed variable x₀ (either in a pixel space or a latent space) intermediate variables x₁, . . . , x_{T} using a Markov chain. The Markov chain gradually adds Gaussian noise to the data to obtain the approximate posterior q(x_{1:T}|x₀) as the latent variables are passed through a neural network such as a U-Net, where x₁, . . . , x_{T} have the same dimensionality as x₀.

The neural network may be trained to perform the reverse process. During the reverse diffusion process 710, the model begins with noisy data x_{T}, such as a noisy media item 715 and denoises the data to obtain the p(xₜ₋₁|xₜ). At each step t−1, the reverse diffusion process 710 takes xₜ, such as first intermediate media item 720, and t as input. Here, t represents a step in the sequence of transitions associated with different noise levels, The reverse diffusion process 710 outputs xₜ₋₁, such as second intermediate media item 725 iteratively until x_{T} reverts back to x₀, the original media item 730. The reverse process can be represented as:

$${p}_{θ} ( {x}_{t - 1} \vert {x}_{t} ) := N ( {x}_{t - 1} ; {μ}_{θ} ( {x}_{t} , t ) , {\sum }_{θ} ( {x}_{t} , t ) ) \qquad ( 1 )$$

The joint probability of a sequence of samples in the Markov chain can be written as a product of conditionals and the marginal probability:

$${x}_{T} : {p}_{θ} ( {x}_{0 : T} ) := p ( {x}_{T} ) {\prod }_{t = 1}^{T} {p}_{θ} ( {x}_{t - 1} \vert {x}_{t} ) \qquad ( 2 )$$

where p(x_{T})=N(x_{T}; 0, I) is the pure noise distribution as the reverse process takes the outcome of the forward process, a sample of pure noise, as input and

$${\prod }_{t = 1}^{T} {p}_{θ} ( {x}_{t - 1} \vert {x}_{t} )$$

represents a sequence of Gaussian transitions corresponding to a sequence of addition of Gaussian noise to the sample.

At interference time, observed data x₀ in a pixel space can be mapped into a latent space as input and a generated data \tilde{x} is mapped back into the pixel space from the latent space as output. In some examples, x₀ represents an original input media item with low quality, latent variables x₁, . . . , x_{T} represent noisy media items, and k represents the generated item with high quality. Diffusion process is an example of, or includes aspects of, the corresponding element described with reference to FIGS. 2, 5, 6, and 11.

Accordingly, an apparatus for image processing is described. One or more aspects of the apparatus include a first image generation model comprising parameters stored in the at least one memory component and trained to generate a color conditioned image based on a color input and a content input, wherein the color conditioned image depicts an image element with a color attribute; a second image generation model comprising parameters stored in the at least one memory component and trained to generate a style conditioned image based on a style input and the content input, wherein the style conditioned image depicts the image element with a style attribute; and a fusion component configured to generate a synthetic image by combining the color conditioned image and the style conditioned image, wherein the synthetic image depicts the image element with the color attribute and the style attribute.

In some aspects, the first image generation model comprises a first diffusion U-Net configured to generate content features and a second diffusion U-Net configured to generate color features. In some aspects, the second image generation model comprises a third diffusion U-Net configured to generate style-content features and a fourth diffusion U-Net configured to generate style features.

Some examples of the apparatus, system, and method further include a conversion component configured to convert the color conditioned image and the style conditioned image into a LAB space. Some examples of the apparatus, system, and method further include a user interface configured to obtain the color input, the content input, and the style input.

### Image Generation Process

The present disclosure describes systems and methods for image generation. Embodiments of the present disclosure include a machine learning model configured to generate attribute constrained images based on a reference image and a content input. In some examples, the machine learning model generates style and color constrained images. In some cases, the content input is a text prompt that describes an element the user wants to depict in the synthetic image. The machine learning model of the present disclosure enables independent control over different attributes based on the reference image.

An embodiment of the present disclosure includes a training-free method that is configured to disentangle and control text-to-image diffusion models on color and style attributes from a reference image. In some cases, embodiments include a training free test-time method that provides for independent control over color and style attributes (obtained from a reference image) while generating images using text-to-image diffusion models. Accordingly, embodiments are able to provide for reference image-based color and style constrained image generation without a need for retraining the machine learning model.

FIG. 8 shows an example of a method 800 for image processing according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

Embodiments of the present disclosure include an image processing apparatus configured to independently control an output of a text-to-image model. In some examples, the text-to-image model is a diffusion model that enables controlling the color and style attributes of a generated image based on a user-provided reference image. By independently controlling the output of the text-to-image mode, an embodiment of the present disclosure is able to customize the output image in a disentangled (i.e., achieve disentangled transfer between color and style from a reference image), training-free manner.

According to an embodiment, the machine learning model transforms the latent code of a content input at test time using feature transformations. Accordingly, by transforming the latent code of a content input, embodiments are able to ensure that the covariance matrix of generated latent codes follows the covariance matrix of the reference image (e.g., color input such as color input 405 described with reference to FIG. 4). As a result, a color conditioned image (such as a color conditioned image 440 described with reference to FIG. 4) is generated that captures color from the color input into a generated image (e.g., color conditioned image 440).

In some cases, the LAB image space includes a disentanglement between color and style. An embodiment of the present disclosure is configured to transform the self-attention feature maps of the image being generated (such as style conditioned image 460) with respect to the feature maps of the reference image (such as style input 445 described with reference to FIG. 4) computed from the L channel.

According to an embodiment, the transformation of the latent code of the content input and the self-attention feature maps are performed at test time. In some cases, each of the said transformations are performed independently. In some cases, each of the said transformations are merged. According to an embodiment of the present disclosure, the captured color and style information is obtained from the same reference image. According to an embodiment of the present disclosure, the captured color and style information is obtained from two different reference images. As a result, a synthetic image is generated that seamlessly fuses the color and style information obtained from either same reference image or two different reference images.

Embodiments of the present disclosure include a latent diffusion model (LDM). In some cases, LDMs comprise an encoder-decoder pair and a separately trained denoising diffusion probabilistic model (DDPM). Further details regarding the DDPM are provided with reference to FIGS. 5-7. In some cases, LDMs use an encoder E to translate an image I into a latent code z. Additionally, LDMs perform iterative denoising and subsequently convert the predicted latent codes back to the pixel space via the decoder D.

According to an embodiment, the training objective of the DDPM Ee is given as E_{z˜E(I),p,∈˜N(0,1),t}[∥∈−∈_{θ}(zₜ, L(p), t)∥], where p denotes any external conditioning factor e.g., a text prompt, which is encoded using text encoder L (e.g., CLIP, T5, etc.). At any timestep t of the denoising process, for a given current latent code zₜ, zₜ₋₁ is generated. In some cases, noise prediction is performed using

$${ϵ}_{θ}^{( t )} ( {z}_{t} , L ( p ) ) .$$

Additionally, for a given value of zₜ and

$${ϵ}_{θ}^{( t )} ( {z}_{t} , L ( p ) ) ,$$

a deterministic sampling is performed to generate zₜ₋₁ as zₜ₋₁=\sqrt{αₜ₋₁z₀}+\hat{x}ₜ, where zₒ(denoised prediction) is given as

$${z}_{0} = \frac{{z}_{t -} \sqrt{1 - {\hat{α}}_{t}}}{\sqrt{{\hat{α}}_{t}}} {ϵ}_{θ}^{( t )}$$

and \hat{x}ₜ (i.e., direction pointing to xₜ) is computed as

$${\hat{x}}_{t} = \sqrt{1 - {α}_{t - 1} - {σ}_{t}^{2}} {ϵ}_{θ}^{( t )} .$$

At operation 805, the system obtains a color input indicating a color attribute, a style input indicating a style attribute, and a content input indicating an image element. In some cases, the operations of this step refer to, or may be performed by, a user interface as described with reference to FIG. 13.

For example, in some cases, the user interface (such as the user interface 1345 described with reference to FIG. 13) of the machine learning model (such as machine learning model 1215 described with reference to FIG. 12 or machine learning model 1300 described with reference to FIG. 13) receives a color input (such as the color input 405 described with reference to FIG. 4), a style input (such as the style input 445 described with reference to FIG. 4), and a content input (such as the content input 410 described with reference to FIG. 4) from a user. In some examples, the image processing apparatus receives the color input, style input, and content input from the user or database or any other data source.

At operation 810, the system generates, using a first image generation model, a color conditioned image based on the color input and the content input, where the color conditioned image depicts the image element with the color attribute. In some cases, the operations of this step refer to, or may be performed by, a first image generation model as described with reference to FIG. 13.

According to an embodiment of the present disclosure, the first image generation model (such as first image generation model 1305 described with reference to FIG. 13) of the machine learning model perform a DDIM inversion process (such as the DDIM process described with reference to FIGS. 5-7). In some cases, the DDIM is performed on the color input to obtain a corresponding latent

$${z}_{t}^{r e f} .$$

An embodiment of the present disclosure includes a denoising process that is based on a user-provided text prompt and a latent zₜ at timestep t. In some cases, the DDIM sampling process computes the noise prediction ∈_{θ}^{(t)}, followed by computing the z₀ for both the color input (such as color input 405 described with reference to FIG. 4) and the image generated based on content input (such as content input 410 described with reference to FIG. 4).

In some cases, a decoder D(⋅) is used to decode the latent code z₀. Accordingly, a color conditioned image (such as color conditioned image 440 described with reference to FIG. 4) is generated, the color conditioned image captures the color from the color input and follows the aspects of content input. For example, in case of a content input given as “a bird”, the machine learning model very initially starts forming some colors (e.g., green) and then the intermediate latent is transformed to manipulate the colors and obtain a bird (e.g., blue bird) that captures the color of a blue cat in the color input (such as color input 405 described with reference to FIG. 4).

At operation 815, the system generates, using a second image generation model, a style conditioned image based on the style input and the content input, where the style conditioned image depicts the image element with the style attribute. In some cases, the operations of this step refer to, or may be performed by, a second image generation model as described with reference to FIG. 13.

According to an embodiment of the present disclosure, the second image generation model (such as second image generation model 1320 described with reference to FIG. 13) of the machine learning model injects key and value feature maps from self-attention blocks of the U-Net from the reference image (such as style input 445 described with reference to FIG. 4). In some cases, the injection is performed based on the self-attention key K and value V feature maps from the reconstruction of the style input (such as style input 445) after converting the style input to grayscale (such as grayscale image 485 described with reference to FIG. 4) and performing a DDIM inversion.

In some cases, a modified self-attention feature map is generated that incorporates features of the content input (such as content input 410 of FIG. 4) and style features. In some cases, the second image generation model generates style content features (such as style content features 455 described with reference to FIG. 4) based on the modified self-attention feature map. The second image generation model decodes the style content features to obtain a style conditioned image (such as style conditioned image 460 described with reference to FIG. 4). Further details regarding this operation are provided with reference to FIG. 9.

At operation 820, the system generates a synthetic image by combining the color conditioned image and the style conditioned image, where the synthetic image depicts the image element with the color attribute and the style attribute. In some cases, the operations of this step refer to, or may be performed by, a fusion component as described with reference to FIG. 13.

In some cases, a fusion component (such as fusion component 1335 described with reference to FIG. 13) of the machine learning model converts style conditioned image (such as style conditioned image obtained in operation 815) to the LAB space and retains the L channel. In some cases, the fusion component of the machine learning model converts color conditioned image (such as color conditioned image obtained in operation 810) to the LAB space and obtains the AB channels. Synthetic image is generated based on combining the L channel of style conditioned image and AB channels of color conditioned image.

The present disclosure describes systems and methods that enable disentangled control over color and style attributes extracted from user-provided reference image. Embodiments of the present disclosure provide a machine learning model configured to perform a training-free process that enables transfer of any of color-only, style-only, or both color-style from a reference image (or a plurality of reference images).

An embodiment of the present disclosure includes a branched architecture for capturing each of color and style of the reference image(s). In some cases, an output from the color branch and style branch (color and style branch as shown with reference to FIG. 4) is used independently (i.e., for single attribute transfer). In some cases, an output from the color branch and style branch (color and style branch as shown with reference to FIG. 4) is merged (i.e., for multiple attribute transfer). In some cases, the machine learning model performs the merging operation with color and style from the same source (i.e., one reference image) or color from one image and style from another image (i.e., two reference images).

FIG. 9 shows an example of a method 900 for generating a color conditioned image according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 905, the system generates content features based on the content input. In some cases, the operations of this step refer to, or may be performed by, a first image generation model as described with reference to FIG. 13.

At operation 910, the system generates color features based on the color input. In some cases, the operations of this step refer to, or may be performed by, a first image generation model as described with reference to FIG. 13.

According to an embodiment of the present disclosure, a DDIM inversion process (such as the DDIM process described with reference to FIGS. 5-7) is performed on the color input (such as color input 405 described with reference to FIG. 4) to obtain a latent

$${z}_{t}^{r e f} .$$

In some cases, as the denoising process begins, the DDIM sampling process compute a noise prediction

$${ϵ}_{θ}^{( t )}$$

based on a user-specified text prompt and a latent zₜ at timestep t.

In some cases, a denoised prediction z₀ is computed for the color input and the content input after computation of the noise prediction

$${ϵ}_{θ}^{( t )} .$$

A decoder D(⋅) is used to then decode the latent code z₀.

At operation 915, the system combines the content features and the color features to obtain color-content features. In some cases, the operations of this step refer to, or may be performed by, a first image generation model as described with reference to FIG. 13.

An embodiment of the present disclosure is configured to perform a K-means clustering operation. For a given timestep t, the first image generation model (such as the first image generation model 1305 described with reference to FIG. 13) performs a K-Means clustering operation. In some cases, the K-means clustering operation is performed on the decoded image

$${I}_{0}^{( t ) gen}$$

and the color input to obtain sets of K color clusters C_{gen} and C_{ref}, respectively. In some cases, the first image generation model masks the decoded latent with cross-attention maps to restrict the object of interest in the decoded image and the color input.

The first image generation model generates a set of masks M_{ref} and M_{gen} for each of the color input and decoded image, respectively, by establishing correspondences between the cluster sets C_{ref} and C_{gen} based on the corresponding proportion. In some cases, a color cluster with the largest membership in the reference image indicates the dominant color that is transferred to the decoded image. For example, a dominant blue color in the color input is transferred to a large element (i.e., with large area) in the decoded image whereas the yellow is transferred to a small element (i.e., with small area) in the decoded image.

The first image generation model achieves the said clustering based on applying a mask-aware recoloring transformation (RT) on the latent code. In some cases, the first image generation model uses the masks M_{ref} and M_{gen} to perform the mask-aware recoloring transformation (RT) on the latent code zot)gen:

$${z}_{0}^{( t ) gen} :$$

$${z}_{0}^{( t ) gen} = \sum [ ( 1 - {m}_{g e n}^{i} ) {z}_{0}^{( t ) gen} + {m}_{g e n}^{i} [ R T ( {m}_{g e n}^{i} {z}_{0}^{( t ) gen} , {m}_{r e f}^{i} {z}_{0}^{( t ) ref} ) ] ] where {m}_{g e n}^{i} ∈ {M}_{g e n} , {m}_{r e f}^{i} ∈ {M}_{r e f} and 1 \leq i \leq K \qquad ( 3 )$$

According to an embodiment, the first image generation model iterates over each of the K clusters and applies the recoloring transform separately to regions determined by masks corresponding to each cluster. Additionally, in case of each iteration i, the first image generation model uses the corresponding mask

$${m}_{g e n}^{i}$$

to constrain the region of color transfer.

### Similarly,

$${m}_{ref}^{i}$$

is used to determine the reference pixels corresponding to a particular color, i.e., pixels where a color is picked. As such, in any iteration i, pixels outside the region of interest (determined by the

$${m}_{gen}^{i} )$$

are not modified.

As used herein, the mask-aware recoloring transformation is a two-step process. In some cases, the first image generation model is used to whiten the latent codes to ensure that the covariance matrix is identity. Next, the first image generation model applies a transformation to match the covariance matrix of the latent codes with the covariance matrix of the color input

$$( {z}_{0}^{( t ) ref} ) .$$

In some cases, color is captured during the early stages of the denoising process. As a result, Equation 3 is restricted to a subset of the initial denoising timesteps, i.e.,

$${t}_{c}^{start} < t < {t}_{c}^{e n d} .$$

In some cases, the updated

$${z}_{0}^{( t ) gen}$$

obtained in Equation 3 is then used along with the predicted noise

$${ϵ}_{θ}^{( t )}$$

to compute color-content features

$${z}_{t - 1}^{g e n} ,$$

which are input to the next denoising step of the diffusion process, ultimately resulting in a denoised prediction.

At operation 920, the system decodes the color-content features to obtain the color conditioned image. In some cases, the operations of this step refer to, or may be performed by, a first image generation model as described with reference to FIG. 13.

In some cases, the color-content features

$${z}_{t - 1}^{g e n}$$

such as color-content features 435 described with reference to FIG. 4) are decoded using a decoder to generate a color conditioned image (such as color conditioned image 440 described with reference to FIG. 4). The color conditioned image captures the color from the color input (obtained in operation 910) while following the description of the content input (obtained in operation 905).

An exemplary embodiment of the present disclosure describes a progression of decoded latents

$${I}_{0}^{( t ) gen}$$

across denoising timesteps. For example, in case of a given prompt “a bird”, the first image generation model initially starts forming some colors (e.g., green) on the bird. Further, the first image generation model transforms the intermediate latents to manipulate the colors using operations 910-915 described herein. Accordingly, the first image generation model obtains a bird (as specified in the content input, such as content input 410 described with reference to FIG. 4) that follows the color of the color input, e.g., a blue bird is generated following a blue cat in the color input.

FIG. 10 shows an example of a method 1000 for generating a style conditioned image according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 1005, the system generates style features based on the style input. In some cases, the operations of this step refer to, or may be performed by, a second image generation model as described with reference to FIG. 13.

At operation 1010, the system generates style-content features based on the content input and the style features. In some cases, the operations of this step refer to, or may be performed by, a second image generation model as described with reference to FIG. 13.

According to an embodiment of the present disclosure, a second image generation model (such as second image generation model 1320 described with reference to FIG. 13) is used to generate style features based on the style input and style-content features based on the content input and the style input. As described with reference to FIG. 13, the second image generation model includes a diffusion model. In some cases, the diffusion model is configured to translate an image I into a latent code z, perform iterative denoising, and subsequently convert the predicted latent codes back to the pixel space via the decoder D (each of these operations are described in detail with reference to FIGS. 4-8). In some cases, high-frequency details such as style and texture influence the later denoising timesteps of the diffusion process.

In some cases, as described with reference to FIG. 4, the second image generation model is configured to inject key and value feature maps from the style input (such as style input 445 described with reference to FIG. 4) to the image generation performed based on the content input 410. For example, the second image generation model is configured to inject key and value feature maps from the third diffusion model (such as third diffusion model 1325 described with reference to FIG. 13) to the later denoising timesteps

$$( t > {t}_{s}^{start} )$$

of the fourth diffusion model (such as fourth diffusion model 1330 described with reference to FIG. 13).

Additionally, as described herein, an L channel captures the content and style and the AB channels capture color information. In some cases, a grayscale version of the style input is used as an approximation to the L channel. An embodiment of the present disclosure is configured to perform DDIM inversion of the style input to obtain the latent

$${z}_{t}^{ref} .$$

Given a user-provided text prompt (e.g., a bird), for each denoising timestep

$$t < {t}_{s}^{start} ,$$

the second image generation model denoises the input latent codes similar to a baseline text-to-image model. In some cases, once the denoising process reaches

$$t > {t}_{s}^{start} ,$$

the second image generation model starts injecting the self-attention key K and value V feature maps from the style input after converting the style input to grayscale and performing a DDIM inversion (such as using third diffusion model 1325 described with reference to FIG. 13).

In some cases, a modified self-attention feature map is generated for the diffusion model (such as fourth diffusion model 1330) corresponding to the content input (such as content input 410 described with reference to FIG. 4). In some cases, the modified self-attention feature map computation at any denoising timestep t and layer l of the U-Net can be expressed as:

$${\hat{f}}_{t}^{l} = {𝕀}_{0 < t < {t}_{s}^{s t a r t}} softmax ( \frac{{Q}_{gen}^{l} ( {K}_{gen}^{l} \cdot T )}{√ {d}_{k}} {V}_{g e n}^{l} ) + {𝕀}_{t > {t}_{s}^{s t a r t}} softmax ( \frac{{Q}_{gen}^{l} ( {K}_{ref}^{l} \cdot T )}{√ {d}_{k}} {V}_{ref}^{l} ) \qquad ( 4 )$$

where I is an indicator, and

$${Q}_{g e n}^{l} / {K}_{g e n}^{l} / {V}_{g e n}^{l} and {Q}_{ref}^{l} / {K}_{ref}^{l} / {V}_{ref}^{l}$$

denote l^{th} U-Net layer self-attention queries, keys, and values for the generation and reference respectively.

At operation 1015, the system decodes the style-content features to obtain the style conditioned image. In some cases, the operations of this step refer to, or may be performed by, a second image generation model as described with reference to FIG. 13.

In some cases, the second image generation model then uses the final latent code (style-content feature 455 described with reference to FIG. 4) and decodes the style-content feature to generate a style conditioned image (such as style conditioned image 460 described with reference to FIG. 4). The style conditioned image captures the style from the style input (obtained in operation 1005) while following the description of the content input. In some cases, the second image generation model converts the style conditioned image to the LAB space, retains the L channel, and obtains the AB channels from the corresponding color conditioned image (such as color conditioned image 440) to generate a synthetic image (such as synthetic image 465 described with reference to FIG. 4).

Accordingly, a method for image processing is described. One or more aspects of the method include generating, using a first image generation model, a color conditioned image based on a color input and a content input, wherein the color conditioned image depicts an image element with a color attribute; generating, using a second image generation model, a style conditioned image based on a style input and the content input, wherein the style conditioned image depicts the image element with a style attribute; converting the style conditioned image and the color conditioned image into a style LAB image and a color LAB image, respectively; and generating a synthetic image by combining the color conditioned image and the style conditioned image, wherein the synthetic image depicts the image element with the color attribute and the style attribute.

A method for image processing is described. One or more aspects of the method include obtaining the content input, the color input, and the style input, wherein the content input indicates the image element, the color input indicates the color attribute, and the style input indicates the style attribute.

A method for image processing is described. One or more aspects of the method include generating content features based on the content input; generating color features based on the color input; combining the content features and the color features to obtain color-content features; and decoding the color-content features to obtain the color conditioned image.

A method for image processing is described. One or more aspects of the method include generating a content mask based on the content features and generating a color mask based on the color features, wherein the content features and color features are combined based on the content mask and the color mask.

A method for image processing is described. One or more aspects of the method include obtaining a content noise map and obtaining a color noise map, wherein the content features are generated by denoising the content noise map and the color features are generated by denoising the color noise map.

A method for image processing is described. One or more aspects of the method include generating style features based on the style input; generating style-content features based on the content input and the style features; and decoding the style-content features to obtain the style conditioned image.

A method for image processing is described. One or more aspects of the method include obtaining a style noise map and obtaining a content noise map, wherein the style features are generated by denoising the style noise map and the style-content features are generated by denoising the content noise map.

A method for image processing is described. One or more aspects of the method include converting the style conditioned image into a style LAB image; converting the color conditioned image into a color LAB image; and combining a channel of the style LAB image with a channel of the color LAB image to obtain the synthetic image.

### Implementation and Evaluation

An exemplary embodiment of the present disclosure is configured to perform disentangled transfer of color and style attributes from a reference image (e.g., color input and style input described with reference to FIG. 4). In some cases, the machine learning model of the present disclosure generates images following the content from the user-provided text prompt (e.g., dog, vase, cat, etc.) while following the style and color from the reference image.

For example, according to an embodiment, the machine learning model accurately follows yellow color specified as part of the text prompt, and captures the style from a user-provided reference image. In some cases, the machine learning model generates images following style or color from the reference image while imposing no control over the other attribute. In some cases, the machine learning model is configured to generate images following the style from the reference image in a disentangled manner without affecting any other aspect or attribute.

According to an exemplary embodiment, the machine learning model is able to accurately transfer the color from the reference image, i.e., while being able to control the color attribute independently. Additionally, embodiments of the present disclosure are configured to provide a training-free test-time method that is able to correctly control and transfer color attribute independently without affecting any other aspects of results of the pretrained model.

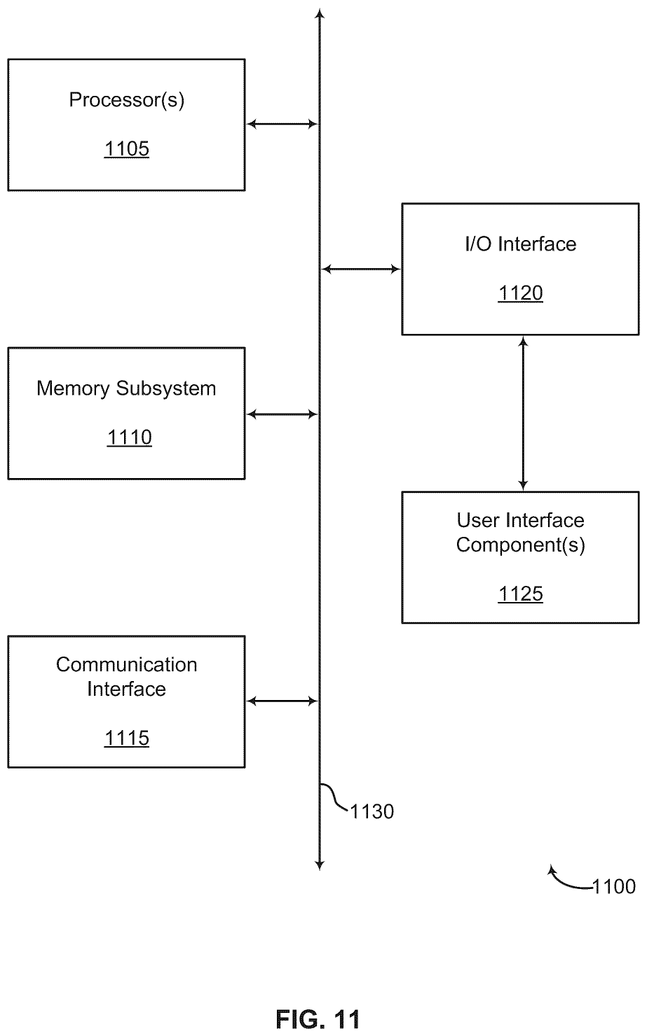

FIG. 11 shows an example of a computing device 1100 according to aspects of the present disclosure. The computing device 1100 may be an example of the image processing apparatus 1200 described with reference to FIG. 12. In one aspect, computing device 1100 includes processor(s) 1105, memory subsystem 1110, communication interface 1115, I/O interface 1120, user interface component(s) 1125, and channel 1130.

In some embodiments, computing device 1100 is an example of, or includes aspects of, the media generation model of FIG. 5. In some embodiments, computing device 1100 includes one or more processors 1105 that can execute instructions stored in memory subsystem 1110 to perform media generation.

According to some aspects, computing device 1100 includes one or more processors 1105. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some aspects, memory subsystem 1110 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 1115 operates at a boundary between communicating entities (such as computing device 1100, one or more user devices, a cloud, and one or more databases) and channel 1130 and can record and process communications. In some cases, communication interface 1115 is provided to enable a processing system coupled to a transceiver (e.g., a transmitter and/or a receiver). In some examples, the transceiver is configured to transmit (or send) and receive signals for a communications device via an antenna.

According to some aspects, I/O interface 1120 is controlled by an I/O controller to manage input and output signals for computing device 1100. In some cases, I/O interface 1120 manages peripherals not integrated into computing device 1100. In some cases, I/O interface 1120 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1120 or via hardware components controlled by the I/O controller.

According to some aspects, user interface component(s) 1125 enable a user to interact with computing device 1100. In some cases, user interface component(s) 1125 include an audio device, such as an external speaker system, an external display device such as a display screen, an input device (e.g., a remote-control device interfaced with a user interface directly or through the I/O controller), or a combination thereof. In some cases, user interface component(s) 1125 include a GUI.

FIG. 12 shows an example of an image processing apparatus 1200 according to aspects of the present disclosure. Image processing apparatus 1200 may include an example of, or aspects of, the guided diffusion model described with reference to FIG. 1 and the U-Net described with reference to FIG. 2. In one aspect, image processing apparatus 1200 includes processor unit 1205, memory unit 1210, machine learning model 1215, and I/O controller 1220. Image processing apparatus 1200 is an example of, or includes aspects of, the corresponding element described with reference to FIG. 1. Machine learning model 1215 is an example of, or includes aspects of, the corresponding element described with reference to FIG. 13.

Processor unit 1205 includes one or more processors. A processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof.

In some cases, processor unit 1205 is configured to operate a memory array using a memory controller. In other cases, a memory controller is integrated into processor unit 1205. In some cases, processor unit 1205 is configured to execute computer-readable instructions stored in memory unit 1210 to perform various functions. In some aspects, processor unit 1205 includes special purpose components for modem processing, baseband processing, digital signal processing, or transmission processing. According to some aspects, processor unit 1205 comprises one or more processors described with reference to FIG. 11.

Memory unit 1210 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause at least one processor of processor unit 1205 to perform various functions described herein.

In some cases, memory unit 1210 includes a basic input/output system (BIOS) that controls basic hardware or software operations, such as an interaction with peripheral components or devices. In some cases, memory unit 1210 includes a memory controller that operates memory cells of memory unit 1210. For example, the memory controller may include a row decoder, column decoder, or both. In some cases, memory cells within memory unit 1210 store information in the form of a logical state. According to some aspects, memory unit 1210 is an example of the memory subsystem 1110 described with reference to FIG. 11.

According to some aspects, image processing apparatus 1200 uses one or more processors of processor unit 1205 to execute instructions stored in memory unit 1210 to perform functions described herein. For example, the image processing apparatus 1200 may obtain a color input indicating a color attribute, a style input indicating a style attribute, and a content input indicating an image element; generate, using a first image generation model, a color conditioned image based on the color input and the content input, wherein the color conditioned image depicts the image element with the color attribute; generate, using a second image generation model, a style conditioned image based on the style input and the content input, wherein the style conditioned image depicts the image element with the style attribute; and generate a synthetic image by combining the color conditioned image and the style conditioned image, wherein the synthetic image depicts the image element with the color attribute and the style attribute.

The memory unit 1210 may include a machine learning model 1215 trained to obtain a color input indicating a color attribute, a style input indicating a style attribute, and a content input indicating an image element; generate, using a first image generation model, a color conditioned image based on the color input and the content input, wherein the color conditioned image depicts the image element with the color attribute; generate, using a second image generation model, a style conditioned image based on the style input and the content input, wherein the style conditioned image depicts the image element with the style attribute; and generate a synthetic image by combining the color conditioned image and the style conditioned image, wherein the synthetic image depicts the image element with the color attribute and the style attribute.

In some embodiments, the machine learning model 1215 is an Artificial Neural Network (ANN) such as the guided diffusion model described with reference to FIG. 5 and the U-Net described with reference to FIG. 6. An ANN can be a hardware component or a software component that includes connected nodes (i.e., artificial neurons) that loosely correspond to the neurons in a human brain. Each connection, or edge, transmits a signal from one node to another (like the physical synapses in a brain). When a node receives a signal, it processes the signal and then transmits the processed signal to other connected nodes.

ANNs have numerous parameters, including weights and biases associated with each neuron in the network, which control the degree of connection between neurons and influence the neural network's ability to capture complex patterns in data. These parameters, also known as model parameters or model weights, are variables that determine the behavior and characteristics of a machine learning model.

In some cases, the signals between nodes comprise real numbers, and the output of each node is computed by a function of its inputs. For example, nodes may determine their output using other mathematical algorithms, such as selecting the max from the inputs as the output, or any other suitable algorithm for activating the node. Each node and edge are associated with one or more node weights that determine how the signal is processed and transmitted. In some cases, nodes have a threshold below which a signal is not transmitted at all. In some examples, the nodes are aggregated into layers.

The parameters of machine learning model 1215 can be organized into layers. Different layers perform different transformations on their inputs. The initial layer is known as the input layer and the last layer is known as the output layer. In some cases, signals traverse certain layers multiple times. A hidden (or intermediate) layer includes hidden nodes and is located between an input layer and an output layer. Hidden layers perform nonlinear transformations of inputs entered into the network. Each hidden layer is trained to produce a defined output that contributes to a joint output of the output layer of the ANN. Hidden representations are machine-readable data representations of an input that are learned from hidden layers of the ANN and are produced by the output layer. As the understanding of the ANN of the input improves as the ANN is trained, the hidden representation is progressively differentiated from earlier iterations.

In some cases, a training component may train the machine learning model 1215. For example, parameters of the machine learning model 1215 can be learned or estimated from training data and then used to make predictions or perform tasks based on learned patterns and relationships in the data. In some examples, the parameters are adjusted during the training process to minimize a loss function or maximize a performance metric. The goal of the training process may be to find optimal values for the parameters that allow the machine learning model to make accurate predictions or perform well on the given task.

Accordingly, the node weights can be adjusted to improve the accuracy of the output (i.e., by minimizing a loss which corresponds in some way to the difference between the current result and the target result). The weight of an edge increases or decreases the strength of the signal transmitted between nodes. For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the machine learning model 1215 can be used to make predictions on new, unseen data (i.e., during inference).

I/O module 1220 receives inputs from and transmits outputs of the image processing apparatus 1200 to other devices or users. For example, I/O module 1220 receives inputs for the machine learning model 1215 and transmits outputs of the machine learning model 1215. According to some aspects, I/O module 1220 is an example of the I/O interface 1120 described with reference to FIG. 11.

FIG. 13 shows an example of a machine learning model 1300 according to aspects of the present disclosure. Machine learning model 1300 is an example of, or includes aspects of, the corresponding element described with reference to FIG. 12. In one aspect, machine learning model 1300 includes first image generation model 1305, second image generation model 1320, fusion component 1335, conversion component 1340, and user interface 1345.

In some examples, first image generation model 1305 and second image generation model 1320 are distinct image generation models trained separately, For example, first image generation model 1305 can be a model trained specifically to incorporate color input and generate a color conditioned output image (e.g. using ground truth color transfer training data) while second image generation model 1320 can be a model trained specifically to incorporate style input and generate a style conditioned output (e.g., using ground truth style transfer training data). However, in some cases, the first image generation model 1305 and second image generation model 1320 can be two copies of the same model run in parallel, or a single model run sequentially to perform their functions as explained herein, including with reference to FIG. 4.

According to some aspects, first image generation model 1305 generates a color conditioned image based on the color input and the content input, where the color conditioned image depicts the image element with the color attribute. In some examples, first image generation model 1305 generates content features based on the content input. In some examples, first image generation model 1305 generates color features based on the color input. In some examples, first image generation model 1305 combines the content features and the color features to obtain color-content features. In some examples, first image generation model 1305 decodes the color-content features to obtain the color conditioned image. In some examples, first image generation model 1305 generates a content mask based on the content features. In some examples, first image generation model 1305 generates a color mask based on the color features, where the content features and color features are combined based on the content mask and the color mask. In some examples, first image generation model 1305 obtains a content noise map. In some examples, first image generation model 1305 obtains a color noise map, where the content features are generated by denoising the content noise map and the color features are generated by denoising the color noise map.

According to some aspects, first image generation model 1305 generates a color conditioned image based on a color input and a content input, where the color conditioned image depicts an image element with a color attribute. According to some aspects, first image generation model 1305 generates content features based on the content input. In some examples, first image generation model 1305 generates color features based on the color input. In some examples, first image generation model 1305 combines the content features and the color features to obtain color-content features. In some examples, first image generation model 1305 decodes the color-content features to obtain the color conditioned image.

According to some aspects, first image generation model 1305 generates a content mask based on the content features. In some examples, first image generation model 1305 generates a color mask based on the color features, where the content features and color features are combined based on the content mask and the color mask.

According to some aspects, first image generation model 1305 obtains a content noise map. In some examples, first image generation model 1305 obtains a color noise map, where the content features are generated by denoising the content noise map and the color features are generated by denoising the color noise map.

According to some aspects, first image generation model 1305 is comprising parameters stored in the at least one memory component and trained to generate a color conditioned image based on a color input and a content input, wherein the color conditioned image depicts an image element with a color attribute. In some aspects, the first image generation model 1305 includes a first diffusion U-Net configured to generate content features and a second diffusion U-Net configured to generate color features. In one aspect, first image generation model 1305 includes first diffusion model 1310 and second diffusion model 1315.

According to some aspects, second image generation model 1320 generates a style conditioned image based on the style input and the content input, where the style conditioned image depicts the image element with the style attribute. In some examples, second image generation model 1320 generates style features based on the style input. In some examples, second image generation model 1320 generates style-content features based on the content input and the style features. In some examples, second image generation model 1320 decodes the style-content features to obtain the style conditioned image. In some examples, second image generation model 1320 obtains a style noise map. In some examples, second image generation model 1320 obtains a content noise map, where the style features are generated by denoising the style noise map and the style-content features are generated by denoising the content noise map.

According to some aspects, second image generation model 1320 generates a style conditioned image based on a style input and the content input, where the style conditioned image depicts the image element with a style attribute. According to some aspects, second image generation model 1320 generates style features based on the style input. In some examples, second image generation model 1320 generates style-content features based on the content input and the style features. In some examples, second image generation model 1320 decodes the style-content features to obtain the style conditioned image.

According to some aspects, second image generation model 1320 obtains a style noise map. In some examples, second image generation model 1320 obtains a content noise map, where the style features are generated by denoising the style noise map and the style-content features are generated by denoising the content noise map.

According to some aspects, second image generation model 1320 is comprising parameters stored in the at least one memory component and trained to generate a style conditioned image based on a style input and the content input, wherein the style conditioned image depicts the image element with a style attribute. In some aspects, the second image generation model 1320 includes a third diffusion U-Net configured to generate style-content features and a fourth diffusion U-Net configured to generate style features. In one aspect, second image generation model 1320 includes third diffusion model 1325 and fourth diffusion model 1330.

According to some aspects, fusion component 1335 generates a synthetic image by combining the color conditioned image and the style conditioned image, where the synthetic image depicts the image element with the color attribute and the style attribute. In some examples, fusion component 1335 combines a channel of the style LAB image with a channel of the color LAB image to obtain the synthetic image.

According to some aspects, fusion component 1335 generates a synthetic image by combining the color conditioned image and the style conditioned image, where the synthetic image depicts the image element with the color attribute and the style attribute. According to some aspects, fusion component 1335 combines a channel of the style LAB image with a channel of the color LAB image to obtain the synthetic image. According to some aspects, fusion component 1335 is configured to generate a synthetic image by combining the color conditioned image and the style conditioned image, wherein the synthetic image depicts the image element with the color attribute and the style attribute.

According to some aspects, conversion component 1340 converts the style conditioned image into a style LAB image. In some examples, conversion component 1340 converts the color conditioned image into a color LAB image. According to some aspects, conversion component 1340 converts the style conditioned image and the color conditioned image into a style LAB image and a color LAB image, respectively.

According to some aspects, conversion component 1340 converts the style conditioned image into a style LAB image. In some examples, conversion component 1340 converts the color conditioned image into a color LAB image. According to some aspects, conversion component 1340 is configured to convert the color conditioned image and the style conditioned image into a LAB space.

According to some aspects, user interface 1345 obtains a color input indicating a color attribute, a style input indicating a style attribute, and a content input indicating an image element. According to some aspects, user interface 1345 obtains the content input, the color input, and the style input, where the content input indicates the image element, the color input indicates the color attribute, and the style input indicates the style attribute. According to some aspects, user interface 1345 is configured to obtain the color input, the content input, and the style input.

Accordingly, a method for image processing is described. One or more aspects of the method include obtaining a color input indicating a color attribute, a style input indicating a style attribute, and a content input indicating an image element; generating, using a first image generation model, a color conditioned image based on the color input and the content input, wherein the color conditioned image depicts the image element with the color attribute; generating, using a second image generation model, a style conditioned image based on the style input and the content input, wherein the style conditioned image depicts the image element with the style attribute; and generating a synthetic image by combining the color conditioned image and the style conditioned image, wherein the synthetic image depicts the image element with the color attribute and the style attribute.

Some examples of the method, apparatus, and non-transitory computer readable medium further include generating content features based on the content input. Some examples further include generating color features based on the color input. Some examples further include combining the content features and the color features to obtain color-content features. Some examples further include decoding the color-content features to obtain the color conditioned image.

Some examples of the method, apparatus, and non-transitory computer readable medium further include generating a content mask based on the content features. Some examples further include generating a color mask based on the color features, wherein the content features and color features are combined based on the content mask and the color mask.

Some examples of the method, apparatus, and non-transitory computer readable medium further include obtaining a content noise map. Some examples further include obtaining a color noise map, wherein the content features are generated by denoising the content noise map and the color features are generated by denoising the color noise map.

Some examples of the method, apparatus, and non-transitory computer readable medium further include generating style features based on the style input. Some examples further include generating style-content features based on the content input and the style features. Some examples further include decoding the style-content features to obtain the style conditioned image.

Some examples of the method, apparatus, and non-transitory computer readable medium further include obtaining a style noise map. Some examples further include obtaining a content noise map, wherein the style features are generated by denoising the style noise map and the style-content features are generated by denoising the content noise map.

Some examples of the method, apparatus, and non-transitory computer readable medium further include converting the style conditioned image into a style LAB image. Some examples further include converting the color conditioned image into a color LAB image. Some examples further include combining a channel of the style LAB image with a channel of the color LAB image to obtain the synthetic image.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method for image processing, comprising:
obtaining a color input indicating a color attribute, a style input indicating a style attribute, and a content input indicating an image element;
generating, using a first image generation model, a color conditioned image based on the color input and the content input, wherein the color conditioned image depicts the image element with the color attribute;
generating, using a second image generation model, a style conditioned image based on the style input and the content input, wherein the style conditioned image depicts the image element with the style attribute; and
combining the color conditioned image and the style conditioned image to obtain a synthetic image, wherein the synthetic image depicts the image element with the color attribute and the style attribute.

2. The method of claim 1, wherein generating the color conditioned image comprises:
generating content features based on the content input;
generating color features based on the color input;
combining the content features and the color features to obtain color-content features; and
decoding the color-content features to obtain the color conditioned image.

3. The method of claim 2, further comprising:
generating a content mask based on the content features; and
generating a color mask based on the color features, wherein the content features and color features are combined based on the content mask and the color mask.

4. The method of claim 2, further comprising:
obtaining a content noise map; and
obtaining a color noise map, wherein the content features are generated by denoising the content noise map and the color features are generated by denoising the color noise map.

5. The method of claim 1, wherein the generating the style conditioned image comprises:
generating style features based on the style input;
generating style-content features based on the content input and the style features; and
decoding the style-content features to obtain the style conditioned image.

6. The method of claim 5, further comprising:
obtaining a style noise map; and
obtaining a content noise map, wherein the style features are generated by denoising the style noise map and the style-content features are generated by denoising the content noise map.

7. The method of claim 1, wherein combining the color conditioned image and the style conditioned image comprises:
converting the style conditioned image into a style LAB image;
converting the color conditioned image into a color LAB image; and
combining a channel of the style LAB image with a channel of the color LAB image to obtain the synthetic image.

8. A non-transitory computer readable medium storing code for image processing, the code comprising instructions executable by a processor to:
generate, using a first image generation model, a color conditioned image based on a color input and a content input, wherein the color conditioned image depicts an image element with a color attribute;
generate, using a second image generation model, a style conditioned image based on a style input and the content input, wherein the style conditioned image depicts the image element with a style attribute;
convert the style conditioned image and the color conditioned image into a style LAB image and a color LAB image, respectively; and
combine the style LAB image and the color LAB image to obtain a synthetic image, wherein the synthetic image depicts the image element with the color attribute and the style attribute.

9. The non-transitory computer readable medium of claim 8, the code further comprising instructions executable by the processor to:
obtain the content input, the color input, and the style input, wherein the content input indicates the image element, the color input indicates the color attribute, and the style input indicates the style attribute.

10. The non-transitory computer readable medium of claim 8, the code further comprising instructions executable by the processor to:
generate content features based on the content input;
generate color features based on the color input;
combine the content features and the color features to obtain color-content features; and
decode the color-content features to obtain the color conditioned image.

11. The non-transitory computer readable medium of claim 10, the code further comprising instructions executable by the processor to:
generate a content mask based on the content features; and
generate a color mask based on the color features, wherein the content features and color features are combined based on the content mask and the color mask.

12. The non-transitory computer readable medium of claim 10, the code further comprising instructions executable by the processor to:
obtain a content noise map; and
obtain a color noise map, wherein the content features are generated by denoising the content noise map and the color features are generated by denoising the color noise map.

13. The non-transitory computer readable medium of claim 8, the code further comprising instructions executable by the processor to:
generate style features based on the style input;
generate style-content features based on the content input and the style features; and
decode the style-content features to obtain the style conditioned image.

14. The non-transitory computer readable medium of claim 13, the code further comprising instructions executable by the processor to:
obtain a style noise map; and
obtain a content noise map, wherein the style features are generated by denoising the style noise map and the style-content features are generated by denoising the content noise map.

15. The non-transitory computer readable medium of claim 8, the code further comprising instructions executable by the processor to:
convert the style conditioned image into a style LAB image;
convert the color conditioned image into a color LAB image; and
combine a channel of the style LAB image with a channel of the color LAB image to obtain the synthetic image.

16. An apparatus for image processing, comprising:
at least one processor;
at least one memory component coupled with the at least one processor;
a first image generation model comprising parameters stored in the at least one memory component and trained to generate a color conditioned image based on a color input and a content input, wherein the color conditioned image depicts an image element with a color attribute; and
a second image generation model comprising parameters stored in the at least one memory component and trained to generate a style conditioned image based on a style input and the content input, wherein the style conditioned image depicts the image element with a style attribute,
wherein the apparatus is configured to combine the color conditioned image and the style conditioned image to obtain a synthetic image, wherein the synthetic image depicts the image element with the color attribute and the style attribute.

17. The apparatus of claim 16, wherein:
the first image generation model comprises a first diffusion U-Net configured to generate content features and a second diffusion U-Net configured to generate color features.

18. The apparatus of claim 16, wherein:
the second image generation model comprises a third diffusion U-Net configured to generate style-content features and a fourth diffusion U-Net configured to generate style features.

19. The apparatus of claim 16, further comprising:
a conversion component configured to convert the color conditioned image and the style conditioned image into a LAB space.

20. The apparatus of claim 16, further comprising:
a user interface configured to obtain the color input, the content input, and the style input.
